(19) United States
(12) Patent Application Publication
(10) Pub. No.: US 2003/0034605 A1
(43) Pub. Date: Feb. 20, 2003

(54) Enhanced keno based game

(76) Inventors: Ian Angus Hunter, Erskineville (AU); Clyde Torkington, North Ryde (AU)

Correspondence Address: COLLEN LAW ASSOCIATES, P.C., Counselors at Law, The Holyoke-Manhattan Building, 80 South Highland Avenue, Ossining, NY, 10562, US

(21) Appl. No.: 09/938,384

(22) Filed: Aug. 24, 2001

(30) Foreign Application Priority Data
Aug. 24, 2000 (AU) PQ 9672

(51) Int. Cl. A63F 13/00

(52) U.S. Cl. 273/138.1; 463/18

(57) ABSTRACT

Methods and software are disclosed for allocating a jackpot award in a keno game. A win value is randomly established between pre-determined limits. Bets on the outcome of the keno game are taken optionally in chronological order. A percentage of each qualified bet is contributed to a jackpot pool. In one embodiment, a qualified bet is selected at random when the contributions cause the pool to equal or exceed the win value. The owner of the selected bet is allocated the win value. In the alternative, a bet whose contribution causes the accumulating pool to equal or exceed the win value results in the owner of the bet to be allocated the win value, regardless of the outcome of the keno game.

### TECHNICAL FIELD

This invention relates to keno based games and more particularly to an enhanced form of a keno based game with a jackpot of variable amount.

### BACKGROUND ART

Keno is a game of chance in which a subset of numbers is drawn at random from a predetermined set of numbers.

The demand exists for variations of keno because it is known that game participants will express a preference for a new form of an already well understood game. Variance of popular or well known games are desirable because they can be played without the need for extensive player instruction and because people tend to prefer games that they know and understand.

It will be understood that the modem keno is deployed over the networks and that computers and computer software are required to implement the collection of bets and other administrative aspects of the game. In this disclosure computer software is used to administer a jackpot and as such, may be deployed over a network which may include one or more venues.

It will be understood that in some embodiments of the keno game, a player participates in the game by purchasing a ticket. The ticket comprises one more bets which may be used by the player during the course of one or more keno games. Where a particular bet is selected as a winning bet of a Mystery Jackpot, the winning bet may be associated by the keno software to a particular ticket. The purchaser or owner of that ticket is allocated a Jackpot Win Value if their ticket includes the selected or winning bet.

### DISCLOSURE OF THE INVENTION

According to the invention there is provided methods and software for an enhanced form of a keno game characterised by the provision of a randomly awarded jackpot of variable amount, allocated to a player irrespective of the outcome of the game.

In preferred embodiments of the invention, the jackpot amount is pre-established, at random, between a lower limit and an upper limit. From each qualifying bet, a contribution in the form of a small percentage of the qualifying bet is contributed to a jackpot pool. When a game's jackpot pool has reached the pre-determined jackpot value, the jackpot winner is announced.

In preferred embodiments, a game prescan software routine chooses, at random, a winning jackpot amount from a range. If the Secret Win Value has been reached or exceeded by player contributions, then the Mystery Jackpot has been won and a winner must be selected. The prescan accumulates, in chronological order, each qualifying bet amount until it has determined which bet provided the contribution which equalled or crossed the Secret Win Value. That ticket is then selected as the Mystery Jackpot winner. In the alternative, a winner is selected at random from all live bets in a game in which the Secret Win Value is reached or exceeded by player contributions.

### MODES FOR CARRYING OUT THE INVENTION

A Mystery Jackpot is where each qualifying bet contributes a small percentage to a jackpot pool. When a keno game's jackpot pool has reached a pre-determined win value, the jackpot winner is announced. Winning a Mystery Jackpot is unrelated to the results of the keno game.

It is understood that a keno game may support various types of bets. The underlying keno game may serve as the basis for any number of different games or bets which ultimately rely on the order or location of the numbers selected during play. A keno game may offer a Mystery Jackpot for all kinds of bets. It is possible to operate a Mystery Jackpot for every type of bet made in the game. It is also possible to restrict qualifying bets to a particular type of bet (ie. standard Keno, Top & Bottom, Odds & Evens, Heads or Tails?, Keno Roulette and Keno Racing). For example, it is possible to offer a Heads or Tails? Mystery Jackpot. Similarly qualifying Mystery Jackpot bets may be restricted to certain hours of play or restricted according to other criteria for the purpose of stimulating participation in a particular form of bet, bet amount, time or venue.

With standard keno, Mystery Jackpots can be restricted to a particular spot size (eg. 9 spot Keno Mystery Jackpot). Spot size refers to the number of numbers a player wishes to select. In some keno games, spot sizes may be 1-10 and 15, for example. Mystery Jackpots on Keno Racing can be restricted to a particular Racing bet (eg. Quartet). Keno Racing is a variation in which each row of numbers is identified to a horse in a race and the winning horse is the one which corresponds to the row of the keno display in which the most numbers is selected.

The chance of winning a Mystery Jackpot relates to the jackpot pool contribution per bet and the valid range of the mystery or randomly selected win value. The average prize for a Mystery Jackpot is the average of the largest possible mystery win value and the lowest possible mystery win value.

A bet that fails to meet the qualification tests for a Mystery Jackpot does not preclude its sale.

Each qualifying ticket for a Mystery Jackpot can win it without any relation to forecasting the drawn results of a game. Each qualifying ticket also contributes a percentage of its value to the jackpot pool. Winning a Mystery Jackpot does not necessarily preclude the ticket from winning any other prize and the Mystery Jackpot value may be excluded from any pro-rating calculations.

In any given game, the keno system software will preselect, from a pre-established range, a secret amount for the jackpot prize (“the Secret Win Value”). If the jackpot pool has reached (or exceeded) this secret amount, a qualifying ticket in the current game will be selected as the jackpot winner once the game has closed (and the opportunity for a cancel/refund on that game has also expired).

Note that an instant-win prize is not part of the keno Mystery Jackpots. Unlike Mystery Jackpot schemes on gaming machines, the availability of ticket cancellations and refunds opens opportunities for fraud and abuse for a prize given at the time of sale. The winner determination is not made or declared until the game has dosed and no further cancellations or refunds are possible. In fact, the Secret Win Value is not checked while the jackpot pool is accumulating.

There is also a game integrity problem should the Secret Win Value be revealed prior to being won. Therefore, the keno system software encrypts the Secret Win Value. A tool does exist to inspect the Secret Win Values, but its use is preferably heavily restricted with passwords. Its use is discouraged unless there is genuine concern with the operation of the keno system.

In order to qualify for a Mystery Jackpot, the bet must:

1. be of the correct type (eg. correct bet type or game type), unless the Mystery Jackpot allows all bet types to qualify; and

2. meet the minimum spend (amount bet) per game for the Mystery Jackpot.

Note that for keno ways bets on a Mystery Jackpot with a particular spot size, the game spend is calculated by the tickets spend per game on that spot size only.

Similarly, a Keno Racing bet on a Mystery Jackpot for a particular type of Racing bet (eg. Quartet), the game spend is calculated by the ticket's spend per game on that Racing bet only.

Consistent with the operation of progressive jackpots, where a ticket has free games, all free games of that ticket are at the end of the ticket's games. A free game on a ticket does NOT contribute the jackpot pools but may still win. Whether or not a free game can win a Mystery Jackpot is an administrative decision.

With Heads or Tails? Let It Run, it is possible for a ticket to initially not qualify for a Mystery Jackpot on its early games due to being below the minimum game spend. But as the Let It Run ticket re-invests larger prizes into future games, it may qualify in those games by meeting or exceeding the minimum game spend test.

Mystery Jackpots must be advertised in order to create public interest. The maximum “coverage” given to a Mystery Jackpot increases the chance of it being witnessed by an irregular Keno player as something to play towards.

Mystery Jackpot have the greatest appeal when the advertised pool is close to the maximum possible secret amount. At this stage, the prize is deemed by the public to be imminent and it becomes a major point of interest.

Keno Mystery Jackpot have been designed to operate on a separate display to other Keno displays. In a PC-based video subsystem, it is intended that a special channel be dedicated to permanently promote Mystery Jackpots when in operation.

The following Mystery Jackpot information is provided to the video subsystem on a regular basis:

1. A short name for the jackpot. Eg. “Mega” Mystery;

2. The minimum possible secret amount set for the jackpot (eg. $5,000.00);

3. The maximum possible secret amount set for the jackpot (eg. $7,000.00);

4. The value of the jackpot pool at the start of the game (eg. $6,789.01);

5. The current value of the jackpot pool (eg. $6,890.12); and

6. The current game number open for sale (eg. 123).

The jackpot value will be at least item 2 above. It must be won before or when item 5 above reaches item 3 above.

Note that due to the (preferred but non-essential) non-instant win nature of the Mystery Jackpot, it is not fair to only advertise items 2, 3 and 5 as the eventual secret amount (if won in this game) is between items 4 and 5 and will almost always be below item 5's value).

While the wording can be varied, a suggested display would be:

Mega Keno Mystery Jackpot

Game 123 Jackpot is between $6,789.01 and $6,890.12

Mega Jackpot must be won between $5,000.00 and $7,000.00

Note that during the game, the item 5 value will be growing as more bets are placed on the game and this is the value of primary interest as it creeps towards item 3. The display should slowly increment the value shown for item 5 towards the last value received.

Should there be more than one Mystery Jackpot in operation, the display should divide display time between them.

At the close of each Keno game (and once the first game result has been entered which prevents cancels and refunds), the system will initiate a “game prescan”.

A normal scan is automatically initiated by the system after each draw completion and confirmation. Designed to be quick in nature, it checks every ticket participating in the drawn game and performs the following list:

1. Calculate the total handle and prizes won for the drawn game;

2. Detects and reports any progressive jackpot winner(s);

3. Detects and reports any Bonus Prize winner(s);

4. Detects, calculates and reports any game pro-rating of major prizes;

5. Accumulates progressive jackpot pool contributions from bets sold from prior games into the next game;

6. Optionally collates player tracking information for an external tracking system;

7. Optionally collects information for the Runner Winners Log facility;

8. Optionally collects information for the windows Game/Winners facility;

9. Broadcasts large winner information through the network;

10. Broadcasts localised winner information to each venue;

11. Update historical game results;

12. Collates ballset statistics, calculates a Chi-square (χ²) result and reports any suspicious results bias;

13. Calculate Heads or Tails? Let It Run re-investments into the next game, including any Mystery Jackpot contributions from such bets;

14. Optionally report a Game Summary report;

15. Optionally report a Game Major Winners report; and

16. Prepares information to help the next game's scan efficiency.

A game prescan is similar to a game scan once all results have been entered and confirmed, but has a different purpose.

The game prescan is interested in the same bets as the normal game scan. It does not need to wait for the game results to be fully determined, and therefore takes advantage of the quiet time during a game drawing to determine the following:

1. Test if any Mystery Jackpot prize pool is due to be won;

2. Detect and report Mystery Jackpot winners;

3. Determine a new Mystery Jackpot Secret Win Value for each Mystery Jackpot that has been won;

4. Accumulates Mystery Jackpot pool contributions from bets sold from prior games into the next game (excludes Heads or Tails? Let It Run bets);

5. Detect and report any optional promotion prize winners;

6. Broadcasts Mystery Jackpot winner information to the network;

7. Broadcasts optional promobonal prize winner information to the network;

8. Broadcasts local Mystery Jackpot winner information to each relevant venue; and

9. Broadcasts local optional promotional prize winner information to each relevant venue.

When the game is actually dosed (ie. sales now start on a new game), the jackpot pool values of all progressive and Mystery Jackpots is remembered. These remembered values will be used to determine jackpot prizes.

Should at the time the game prescan commences, the current value of the Mystery Jackpot pools be lower than at the time of game closed (eg. a large bet cancelled occurred after game close), the lower of these values will be utilised for determining if a Mystery Jackpot has been won.

The jackpot pool amount is compared to the Secret Win Value. If he Secret Win Value h*as been reached or exceeded, then the Mystery Jackpot has been won in the closed game and a winner must be selected. The Mystery Jackpot prize amount to be given to the winner is the Secret Win Value and not the current value of the Mystery Jackpot pool.

In order to select a Mystery Jackpot winner, the game prescan has already accumulated knowledge (via bet sales, prior game prescans, prior normal game scans and bet cancel/refunds), how many qualifying chances are in the drawing game. The selection of a Mystery Jackpot Winner may be accomplished in at least two distinct ways. According to one variation, each live qualifying bed in a game in which the Secret Win Value has been reached is allocated a chance. The system software selects one of these chances at random and identifies the chance to the keno ticket which is deemed the winning ticket. In this way, each qualifying bet is eligible to be selected at random regardless of the outcome of the game or whether or not that was successful in respect of the game outcome. In a second variation, and where each bet in a game is time stamped, the winner is selected by examining the time stamps of the various live qualifying bets and determining which bet was the one associated with a contribution which caused the jackpot pool to equal or exceed the Secret Win Value.

Note that calculation of the qualifying bet amounts cannot be directly derived from jackpot pool contributions due to free games on tickets.

A short description of the winning Mystery Jackpot ticket is distributed to the display equipment at the venue where the ticket was sold (eg. “4 NUMBER KENO BET”). It is important that the serial number of the winning ticket is not revealed publicly, although it is available to the Keno Supervisors and Hotline operators.

The normal game scan's Major Winners will list each Mystery Jackpot winner.

Whenever a game prescan has determined a Mystery Jackpot winner, or a new Mystery Jackpot is introduced to the system overnight, the Keno system will select a Secret Win Value for that jackpot.

At each game prescan, the new Secret Win Value will be a random number somewhere between the new jackpot pool (after deduction of the winning amount, addition of the fill amount and transfer of any secondary jackpot pool but prior to addition of future game bet contributions) and the maximum win value. The random value range includes the new jackpot pool value and the maximum win value and all values in-between. In the alternative, a Secret Win Value may be established and left unchanged until such time as the Secret Win Value is equalled or exceeded by player contributions. In this way the Secret Win Value can either change from game to game or remain unaltered until such time as it is won.

As amounts paid to winners are in multiples of the system monetary unit (eg. 10 cents for Australia/NZ, 1 peso for Philippines, 5 cents for USA, 10 sens for Malaysia), the Secret Win Value will be a multiple of this amount. Should the new jackpot pool value not be a multiple, the Secret Win Value will at least be the next multiple up from the new pool.

For a new Mystery Jackpot, the Secret Win Value will be determined by end-of-night processing and will be selected between the minimum win value and maximum win value, and the jackpot will start with just the fill amount.

The Secret Win Value is held in an encrypted form and the encryption key used changes daily. The Secret Win Value is actually stored twice in order to detect any corruption. The encryption prevents inspection of memory or data files by those with technical knowledge.

Viewing the Secret Win Value should be discouraged. Ideally, this value should never be able to be revealed as it could give advantage to those in the know. However, there will always be a case where inspection may be required to ensure game integrity and also used for testing the facility.

A program called mystery is able to run on the keno software system console when the Keno game is operating and preferably only upon entry of a supervisor's login. However, the program subjects the operator to the same passwords as the prize table editor. In preferred embodiments the prize table may only be edited or the Secret Win Value inspected upon entry of passwords held by a governmental or regulatory authority as well as passwords held by the game operator or its delegated superviser. The program lists all current Mystery Jackpot values in cents/sens/pesos on the console.

The invention proposes, for example, a maximum of ten (10) jackpots, irrespective of whether they are mystery or progressive jackpots. There is no limit on how many Mystery Jackpots a bet may qualify to participate.

Jackpot pool contributions may be set in 100ths of 1% of the bet's game value. This also applies to splitting the contribution between Primary, Secondary and Reimbursement accounts for a jackpot.

The AWA Keno system accumulates jackpot pools in as little as 10,000ths of one cent/peso/sens. No reporting is made of partial cents held by the system. The partial cents are silently held by the system and are used to accurately total or report very small jackpot account contributions.

A jackpot's minimum win value and maximum win value must be in multiples of the system monetary unit (eg. 10 cents).

Every five seconds, the system will broadcast a new jackpot pool update to display equipment. If there are ten (10) jackpots, each jackpot will be updated on displays every fifty (50) seconds.

Jackpot pools, in preferred embodiments, may not exceed 21 million/ringgits or 2.1 billion pesos. Game operators are recommended to avoid configuring jackpots that may possibly get close to these limits.

Mystery and Progressive Jackpots share the following attributes:

1. Each jackpot is independently operated and are not related.

2. A bet may win multiple jackpots.

3. Each jackpot pool can optionally be split into three accounts—Primary, Secondary and Reimbursement.

4. The Primary account is the value shown to the public as the current pool value.

5. The Secondary account is a value accumulated to boost the initial value of the next jackpot once the current jackpot has been won.

6. The Reimbursement account can be utilised to artificially boost the current Primary account and recoup those funds from future pool contributions.

7. Each jackpot has a Fill amount. This is the starting amount for a new or refreshed Primary jackpot account. The Fill amount is usually funded by odds. For a Mystery Jackpot, this is also the Minimum Win value.

8. When a jackpot has been won, the amount won is deducted from the Primary account. The remainder is usually a factor of rounding with shared progressive jackpots, a non-multiple of the monetary unit value that cannot be distributed and/or a Mystery Jackpot win difference from the current pool value.

9. The Fill amount for the jackpot is then added to the remainder in the Primary account.

10. After the Fill amount addition, the Secondary account (excluding partial cents) is transferred on top of the Primary account. The Secondary account will be emptied with the transfer unless the Primary account has reached its maximum.

11. There is a maximum amount for a Primary account. Should contributions attempt to exceed this limit, excess funds are transferred into the Secondary or Reimbursement accounts as appropriate. For Mystery Jackpot, this is also the Maximum Win Value.

12. When each jackpot-qualifying bet is sold, the first game's jackpot contribution is determined by the set percentage of the bet's game/way value. This bet contribution amount is then distributed amongst the Primary, Secondary and Reimbursement accounts.

13. As a multiple-game bet continues play, each non-free game continues to contribute to the jackpot accounts at the end of each normal game scan.

14. When a bet is cancelled or paid early (refund), the next game's contributions are deducted from the jackpot accounts. Note that it may not be possible to recover the exact split between Primary, Secondary and Reimbursement accounts made at the time of sale.

15. When the Reimbursement account is negative (ie. there is an outstanding amount of funds yet to be recovered), jackpot contributions are split between the Primary and Reimbursement accounts. The split of contributions is determined according to the current level of the Reimbursement account.

16. When the Reimbursement account has been reclaimed, jackpot contributions are split between the Primary and Secondary accounts. The split of contributions is determined according to the current level of the Primary account.

17. Jackpot prizes when paid are in multiples of the system monetary unit (eg. 10 cents in Australia/New Zealand and 5 cents for the USA).

18. A jackpot can be created by using the prize table editor program called prize and will be available from the first game drawn on the next day.

19. Jackpot Account Maintenance to transfer funds between Primary, Secondary and Reimbursement accounts can only be performed after the last game of the day has been completed.

20. When a jackpot has been disabled via program prize, it will no longer be available from the first game on the next day.

21. The current Primary, Secondary and Reimbursement account values can be reviewed via the keno Supervisor screen Money/Totals.

The following features are specific to Mystery Jackpots and do not apply to progressive jackpots:

1. It is preferred that a free ticket (ie. cost $0.00) cannot win a mystery jackpot. This rule may be altered by administrative decision.

2. The Secret Win Value will be selected at random between (inclusive) the Minimum Win Value and the Maximum Win Value. Every value in this range is equally possible, although it must be a multiple of the system monetary unit.

3. The Minimum Win Value is set as the jackpot's Fill Amount.

4. The Maximum Win Value is set as the jackpot's Maximum Jackpot Amount.

5. When the Jackpot Account Maintenance function is used to boost the Primary account, a new Secret Win Value will be selected between the new Primary account and the Maximum Win Value.

6. When a Mystery Jackpot configuration has been altered with prize, the existing Mystery Jackpot will preferably continue to operate until won at its Secret Win Value. Jackpot contributions will continue at the old percentage until won and will contribute all funds directly to the Primary account (or Secondary if the maximum has been reached).

7. Unlike progressive jackpots, a game ticket comprising multiple game bets purchased prior to the introduction of a mystery jackpot can still win the mystery jackpot despite the fact that some bets did not contribute to the first game of the Mystery Jackpot.

8. Once the Primary account has reached in a game, the Maximum Win Value, the Mystery Jackpot must be won in the game, or the next game if so required by system or software requirements.

Using a prize table maintenance program (eg. prize), Mystery Jackpots are set under the Main Menu item Jackpots.

Prize Table Maintenance

| | |
|---|---|
| 0. | Exit |
| 1. | Game Characteristics >> |
| 2. | Keno Prize Tables >> |
| 3. | Top and Bottom Prize Tables >> |
| 4. | Odds and Evens Prize Tables >> |
| 5. | Heads or Tails? Prize Tables >> |
| 6. | Pro-rate Prize Table Pools >> |
| 7. | Jackpots >> |
| 8. | Non-monetary (GIFT) Prizes >> |
| 9. | Lucky Last >> |
| 10. | Keno Roulette Prize Table >> |
| 11. | Keno Racing Prize Table >> |
| 12. | Reports |
| 13. | Save Changes |

Enter your selection (0-13): 7
(Note: the menu item numbers may change according to the current version of the software)

One is prompted to select a Jackpot reference number. This number is used with some other displays and reports (eg. Major Winners report and Money/Totals screen) in order to help differentiate between different Mystery Jackpots. Normally, the Jackpot reference number matches the Keno spot size of a progressive jackpot. However, for Keno Racing and Mystery Jackpots, this number does not represent the type of jackpot.

Enter Jackpot Reference Number (1-10): 4

The screen that follows has all of the configuration information for the Mystery Jackpot. Progressive jackpots share the same screen but also must be referenced from the appropriate prize table(s) against the match (eg. 10 out of 10). You are not required to enable the Jackpot setting against each spot prize in the fixed odds tables for Mystery Jackpots.

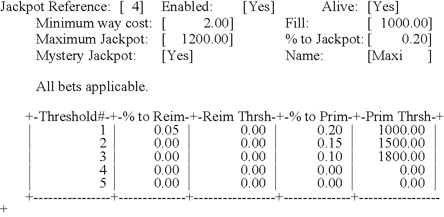

Jackpot Maintenance Menu

| | |
|---|---|
| 0. | Return to Menu |
| 1. | Enabled |
| 2. | Alive |
| 3. | Minimum cost |
| 4. | Fill |
| 5. | Maximum Jackpot |
| 6. | % to Jackpot |
| 7. | % to Reimburse |
| 8. | Reim. Threshold |
| 9. | % to Primary |
| 10. | Primary Threshold |
| 11. | Mystery Jackpot |
| 12. | Jackpot Name |
| 13. | Bet Type |
| 14. | Spots/Bet Option |

Enter Your Selection 90-14):

The following is a description of each item above:

Return Menu: select this once you have completed all other configuration items for the jackpot. You will then need to save your changes in order for them to take effect on the next Keno day.

Enabled: Unless this is set to YES, the jackpot will not become effective.

Alive: This should match the setting for Enabled. In a future release, this option will assist a jackpot being decommissioned on the next win.

Minimum cost: For progressive jackpots, this is the minimum cost per way in order to sell a bet playing for the jackpot. For Mystery Jackpots, this limit enforces the minimum game cost in order to contribute and win the Mystery Jackpot. For instance, once could set a “high roller” $10 Mystery Jackpot in which case a minimum spend of $10 per game in order to win the prize. When the Mystery Jackpot is set for a specific spot size or Racing bet, the bet must play over this limit per game for that spot size/Racing bet.

Fill: This is the initial starting amount for a jackpot and is used to provide the initial funds for the jackpot primary pool after a win. For

Mystery Jackpots, this is also the minimum win value for the Secret Win Value.

Maximum Jackpot: This is the maximum amount that the Primary account may reach. Further contributions will be directed at the Secondary and Reimbursement accounts. For Mystery Jackpots, this is also the maximum win value for the Secret Win Value.

% to Jackpot: this is the overall percentage taken of each bet amount which is contributed to grow the jackpot accounts. It may be in the range of 0.00% to 100.00% with precision to 100ths of 1%. This total jackpot contribution amount will then be split between the Primary, Secondary and/or Reimbursement accounts.

% to Reimburse: When a Reimbursement account is active (ie. negative), this setting alone with Reim. Threshold, controls the split of the jackpot contribution between the Primary and Reimbursement accounts. As each threshold level of the Reimbursement account is met, the percentage set is applied to the bet amount to determine the contribution to the Reimbursement account. The remainder of (jackpot contribution—Reimbursement contribution) will be added to the Primary account.

Reim. Threshold: When the Reimbursement account is active, if the amount below zero exceeds this level's threshold, the % to Reimburse percentage will be applied to determine the split between the Primary and Reimbursement accounts. It is recommended that the first Reim. Threshold amount is zero to ensure final contributions to the Reimbursement account occur to bring it back to zero. Other threshold levels should be in monetary order.

% to Primary. When the Reimbursement account is not active, jackpot contributions are split between the Primary and Secondary accounts. Combined with Primary Threshold, this setting allows different levels of splits according to the current level of the Primary account. The percentage is applied to the bet amount. The remainder (jackpot contribution—Primary contribution) will be added to the Secondary account.

Primary Threshold: When the reimbursement account is not active, if the jackpot Primary account exceeds this threshold, the % to Primary percentage at this level will be applied to split the contribution between the Primary and Secondary accounts. The first threshold amount should be at or below the Fill amount. Other threshold levels should be in monetary order.

Mystery Jackpot This tells the system whether the jackpot is to be won on a mystery basis or on a progressive basis. YES means a mystery jackpot and NO means a progressive jackpot. An enabled progressive jackpot must be referenced from a fixed odds prize table (ie. Keno spot or exotic Keno Racing bet).

Jackpot Name; This short name for a jackpot is used in display messages and other reports. When operating multiple Mystery Jackpots, this helps determine which jackpot is which. It is highly recommended that each Mystery Jackpot be given a name. You may also name progressive jackpots if you wish.

Bet Type: For progressive jackpots, this must be either (standard) Keno or Keno Racing. However, for Mystery Jackpots, you will be presented with the following list of options. Selecting zero means every bet on the system can qualify for the Mystery Jackpot (providing it meets the game cost criteria). At present, Concepts C and D are not yet available.

| | |
|---|---|
| Bet Type 0: | ALL Bets |
| Bet Type 1: | Keno Bet |
| Bet Type 2: | Top & Bottom |
| Bet Type 3: | Odds & Evens |
| Bet Type 4: | Heads/Tails? |
| Bet Type 5: | Roulette |
| Bet Type 6: | Keno Racing |
| Bet Type 7: | Concept C |
| Bet Type 8: | Concept D |
| | Bet Type for Jackpot (0-8): |

Spots/Bet Option: When Bet Type of either Keno or Keno Racing has been selected, there exists the possibility of further refining qualifying bets to a particular Keno spot size or particular exotic Keno Racing bet. There is also the option zero to enable all Keno bets or all Keno Racing bets. The zero option is not available with progressive jackpots.

An example of Spots/Bet Option with standard Keno:

Spot Size for this Jackpot (0=all) (0-20):

An example of Spots/Bet Option with Keno Racing on a Mystery Jackpot:

Keno Racing Exotic Bets:

| | |
|---|---|
| 0. | ALL Racing |
| 9. | QUARTET |
| 10. | SUPERFECTA |
| 11. | FIVE UP |
| 12. | DOUBLE |
| 13. | TREBLE |
| 14. | PICK-4 |
| 15. | DOUBLEQPLC |
| 16. | DOUBLEQUIN |
| 17. | DOUBLETRIO |
| 18. | TRIPLEQPLC |
| 19. | TRIPLEQUIN |
| 20. | TRIPLETRIO |
| | Exotic Racing Bet Number for Jackpot (0-20): |

Mystery Jackpots may be funded by a reduction in commission to the operators of the game with the resultant increase in return to the players. Variations can include in-House jackpots that are only available at one venue and many-linked jackpots that are only available in a specific group of clubs or venues such as venues which share a particular brand, service clubs or league clubs.

In preferred forms of the invention, the Mystery Jackpot software and system provides multiple prize levels (subject to a minimum of three tiers), narrow prize spreads and frequent small level wins.

Using this criteria an adaptation of the Mikhon Jackpot Simulator, the following jackpot levels could be used:

| | | Min | Max |
|---|---|---|---|
| Option 1 | Level 1 | $5,000 | $10,000 |
| | Level 2 | $500 | $1,000 |
| | Level 3 | $50 | $100 |
| Option 2 | Level 1 | $1,000 | $5,000 |
| | Level 2 | $100 | $500 |
| | Level 3 | $50 | $100 |
| Option 3 | Level 1 | $500 | $1,000 |
| | Level 2 | $200 | $500 |
| | Level 3 | $100 | $200 |

The jackpot simulator spreadsheets can determine the jackpot frequency and funding levels for each of the above options. The level of funding can be set as desired such as, for example, 2% of turnover which could offer both an acceptable level of commission reduction and good prize levels.

Constant and dynamic display of the jackpot amounts as they build is desirable to ensure success with the random Mystery Jackpot of the invention.

Various modifications may be made in details of design concept and mode of operation without departing from the scope and ambit of the invention.

I claim:

1. A method of allocating a jackpot award in a keno game, comprising the steps of:
establishing, at random, a win value for a jackpot pool;
receiving bets in chronological order for the game;
diverting a percentage of at least some of the bets to the jackpot pool, bets from which a percentage is diverted being deemed qualified bets;
closing the game to further betting, then comparing the amount actually diverted to the pool to the win value;
determining if the amount actually diverted to the pool equals or exceeds the win value, then
allocating to an owner of a qualified bet an amount equal to the win value if the determination is that the win value has been equalled or exceeded.

2. The method of claim 1, wherein:
allocation is accomplished by selecting one qualified bet, at random, from among all qualified bets for the game.

3. The method of claim 1, wherein:
allocation is accomplished by associating each qualified bet with a time stamp, then determining which bet caused the pool to equal or exceed the win value.

4. The method of claim 3, wherein:
the win value for a first game is selected initially from within a range then if not allocated in the first game, re-selected, from within the range, at random in a next game.

5. The method of claim 1, wherein:
a game number or identifier and the value of the amount actually diverted to the jackpot pool at the start of a game is displayed publicly.

6. The method of claim 5, wherein:
the amount currently in the jackpot pool is also displayed publicly.

7. The method of claim 5, wherein:
more than one jackpot pool is in operation and the public display indicates the amount actually diverted to each jackpot pool.

8. The method of claim 1, wherein:
the determination is made during a game prescan which is conducted before a result of the keno game is fully determined but after the close of betting.

9. The method of claim 1, wherein:
the win value is stored in an encrypted form and the encryption key changes regularly, the win value being stored more than once in order to detect corruption, the stored value requiring a password of a supervisory user.

10. The method of claim 1, wherein:
the diverted percentage of a bet comprises a contribution which is set by a user to some 100ths of 1% of a bet's monetary value.

11. The method of claim 1, wherein:
each jackpot pool may be split into Primary, Secondary and Reimbursement accounts;
the Primary account being the value shown publicly as a current pool value;
the Secondary account being a value accumulated to boost an initial value of a next jackpot; and
the Reimbursement account can be utilised to artificially boost the current Primary account and recoup those funds from future pool contributions.

12. Software or machine readable media for implementing the allocation of a jackpot in a keno game comprising modules or code for performing the following functions:
establishing, at random, a win value for a jackpot pool;
receiving bets in chronological order for the game;
diverting a percentage of at least some of the bets to the jackpot pool, bets from which a percentage is diverted being deemed qualified bets;
closing the game to further betting, then comparing the amount actually diverted to the pool to the win value;
determining if the amount actually diverted to the pool equals or exceeds the win value, then
allocating to an owner of a qualified bet an amount equal to the win value if the determination is that the win value has been equalled or exceeded.

13. The software or machine readable media of claim 12, where:
allocation is accomplished by selecting one qualified bet, at random, from among all qualified bets for the game.

14. The software or machine readable media of claim 12, where:
allocation is accomplished by associating each qualified bet with a time stamp, then determining which bet caused the pool to equal or exceed the win value.

15. The software or machine readable media of claim 14, where:
the win value for a first game is selected initially from within a range then if not allocated in the first game, re-selected, from within the range, at random in a next game.

16. The software or machine readable media of claim 12, where:
a game number or identifier and the value of the amount actually diverted to the jackpot pool at the start of a game is caused by the software to be displayed publicly.

17. The software or machine readable media of claim 16, where:
the amount currently in the jackpot pool is also caused by the software to be displayed publicly.

18. The software or machine readable media of claim 16, where:
more than one jackpot pool is in operation and the public display indicates the amount actually diverted to each jackpot pool.

19. The software or machine readable media of claim 12, where:
the determination is made during a game prescan which is conducted before a result of the keno game is fully determined but after the close of betting.

20. The software or machine readable media of claim 12, where:
the win value is stored in an encrypted form and the encryption key changes regularly, the win value being stored more than once in order to detect corruption, the stored value requiring a password of a supervisory user.

21. The software or machine readable media of claim 12, where:
the diverted percentage of a bet comprises a contribution which is set by a user to some 100ths of 1% of a bet's monetary value.

22. The software or machine readable media of claim 12, where:
each jackpot pool may be split into Primary, Secondary and Reimbursement accounts;
the Primary account being the value shown publicly as a current pool value;
the Secondary account being a value accumulated to boost an initial value of a next jackpot; and
the Reimbursement account can be utilised to artificially boost the current Primary account and recoup those funds from future pool contributions.
